(19) United States
(12) Patent Application Publication
(10) Pub. No.: US 2017/0190832 A1
(43) Pub. Date: Jul. 6, 2017

(54) THERMOPLASTIC AROMATIC POLYESTERS COMPRISING TETRAHYDROFURAN-DIMETHANOL MOTIFS

(71) Applicant: ROQUETTE FRERES, Lestrem (FR)

(72) Inventors: Nicolas JACQUEL, Lambersart (FR); Gabriel DEGAND, Lambres (FR); Rene SAINT-LOUP, Lomme (FR)

(21) Appl. No.: 15/308,661

(22) PCT Filed: May 5, 2015
(86) PCT No.: PCT/FR2015/051186

§ 371 Date: Nov. 3, 2016

(30) Foreign Application Priority Data
May 9, 2014 (FR) 14 54175

(51) Int. Cl. C08G 63/189; C08G 63/183; C08G 63/42; C08G 63/181

(52) U.S. Cl. CPC C08G 63/189; C08G 63/181; C08G 63/183; C08G 63/42

(57) ABSTRACT

A thermoplastic polyester includes: at least one tetrahydrofuran-dimethanol diol motif (A); and at least one aromatic acid motif (B) selected from terephthalic acid, isophthalic acid, phthalic acid, 2,6-naphthalene dicarboxylic acid and 1,4-naphthalene dicarboxylic acid, the glass transition temperature thereof being higher than, or equal to, 50° C. A method for producing polyester including the motifs (A) and (B) is also described.

### FIELD OF THE INVENTION

The present invention relates to thermoplastic polyesters comprising tetrahydrofuran-dimethanol and aromatic diacid units. A subject of the invention is also a process for producing said polyester and the use of this polyester for producing compositions and articles.

### TECHNOLOGICAL BACKGROUND OF THE INVENTION

Because of their numerous advantages, plastics have become inescapable in the mass manufacture of objects. Indeed, because of their thermoplastic nature, it is possible to manufacture objects of any type from these plastics, at a high rate.

Certain aromatic polyesters are thermoplastic and have thermal properties which allow them to be used directly for the manufacture of materials. They comprise aliphatic diol and aromatic diacid units. Among these aromatic polyesters, mention may be made of polyethylene terephthalate (PET), which is a polyester comprising ethylene glycol and terephthalic acid units, used for example in the manufacture of containers, packagings or else textile fibers.

According to the invention, the term “monomeric units” is intended to mean units, included in the polyester, which can be obtained after polymerization of a monomer. With regard to the ethylene glycol and terephthalic acid units included in PET, they can either be obtained by esterification reaction of ethylene glycol and terephthalic acid, or by transesterification reaction of ethylene glycol and terephthalic acid ester.

The development of polyesters resulting from biological resources renewable in the short term has become an ecological and economic imperative, in the face of the exhaustion and of the increase in costs of fossil resources such as oil. One of the main concerns today in the polyester field is therefore that of providing polyesters of natural origin (biobased polyesters). This is particularly true for polyesters comprising aliphatic diol and aromatic acid units. Thus, groups such as Danone or Coca-Cola today market drink bottles made of partially biobased PET, this PET being manufactured from biobased ethylene glycol. One drawback of this PET is that it is only partially biobased, since the terephthalic acid is for its part generally derived from fossil resources. However, processes for synthesizing biobased terephthalic acid and biobased terephthalic acid ester have recently been developed, thereby allowing the manufacture of totally biobased PET. Mention may thus be made of application WO 2013/034743 A1 which describes in particular such PETs.

However, for certain applications or under certain conditions of use, these polyesters do not exhibit all the required properties. This is why glycol-modified PETs (PETg) have been developed. They are generally polyesters comprising, in addition to the ethylene glycol and terephthalic acid units, cyclohexanedimethanol (CHDM) units. The introduction of this diol into the PET allows it to adapt the properties to the intended application, for example to improve its impact resistance or its optical properties, in particular when the PETg is amorphous.

Other CHDM-based polyesters, for instance poly(cyclohexylenedimethyl terephthalate) (PCT) have also already been described.

Moreover, a process for synthesizing CHDM from biobased resources has already been described in document US 2010/0168461 A1. However, this production process remains relatively complex and expensive. Furthermore, the introduction of a CHDM unit into PET can make it possible to render it amorphous, and thus to improve its optical and impact resistance properties, but this is true only for quite specific proportions of CHDM (Turner et al., J Pol Sci Pol Chem 2004, 42, 5847), of between 20 and 40 mol % of CHDM relative to the total amount of diol included in the polyester.

Likewise, the introduction of CHDM increases the glass transition temperature of the polymer. Furthermore, other than in the range between 20 and 40 mol % of CHDM, the polymer is semicrystalline and has a melting temperature generally above 200° C. Thus, in order to be able to transform PETg by means of thermoplastic transformation methods, it is therefore necessary to heat it to a higher temperature or even a much higher temperature in the case where the polyester is semicrystalline. It is therefore necessary to find new polyesters, the constituent monomers of which can be biobased, making it possible to obtain similar properties, or even properties exceeding some of the properties of PET and of PETg comprising oil-based glycol units.

In the context of its research, the applicant has succeeded in producing polyesters which are at least partially biobased, comprising particular aromatic acid units and tetrahydrofuran-methanol (THFDM) units, and also, optionally, additional aliphatic diol units, these polyesters having, as emerges in the remainder of the description, advantageous thermal properties which allow them to be formed by conventional thermoplastic transformation techniques.

Thus far, polyesters comprising tetrahydrofuran-dimethanol units, with sufficient thermal properties that can be formed by thermoplastic techniques, have never been described.

Among the documents describing such polyesters, mention may be made of application JP 39-24730 which describes a prepolymer produced from ethylene glycol, dimethyl terephthalate and tetrahydrofuran-dimethanol. The prepolymer obtained melts at 50° C. and this melting temperature is totally unacceptable for certain uses, since the polymer has insufficient thermomechanical properties and cannot be exposed to any source of heat without the risk of deforming, or even melting, following this exposure. This prepolymer is thus intended to be used together with a curing catalyst, so as to thus form a three-dimensional network, this thermoset resin enabling use at higher temperatures.

### SUMMARY OF THE INVENTION

A subject of the invention is thus a thermoplastic polyester comprising diol units and aromatic acid units and characterized in that it comprises:
at least one tetrahydrofuran-dimethanol diol unit (A);
and at least one aromatic acid unit (B) chosen from terephthalic acid, isophthalic acid, phthalic acid, 2,6-naphthalenedicarboxylic acid and 1,4-naphthalenedicarboxylic acid;
   the glass transition temperature of which is greater than or equal to 50° C.

This polyester has properties which allow it to be readily transformed by thermoplastic transformation techniques. The heat-resistance properties and also its mechanical properties allow it to be used for the production of any type of plastic object, this object possibly being used in many applications.

Furthermore, and as appears in the examples hereinafter, the introduction of tetrahydrofuran-dimethanol (THFDM) units into PET makes it possible to drastically reduce its crystallinity using THFDM, or even to render it amorphous, in comparison with cyclohexanedimethanol (CHDM).

Document WO 2013/149222 describes a polyester comprising aliphatic diol and furandicarboxylic acid units. It does not describe polyesters comprising aromatic acid units that are of use in the invention in combination with tetrahydrofuran-dimethanol units. Furthermore, it does not suggest how to obtain a polyester of low crystallinity while at the same time maintaining its glass transition temperature at 50° C. or above.

### BRIEF DESCRIPTION OF THE FIGURES

FIG. 1 represents the glass transition temperature of a polyester comprising ethylene glycol, terephthalic acid and THFDM or CHDM units, as a function of the amount of THFDM or CHDM in the polyester. The amorphous polyesters are reported as hollow motifs and the semicrystalline polyesters are reported as solid motifs.

FIG. 2 represents the ¹H NMR spectrum of a poly(ethylene-co-isosorbide-co-tetrahydrofuran-dimethanol terephthalate).

### DETAILED DESCRIPTION OF THE INVENTION

This polyester comprises at least one tetrahydrofuran-dimethanol unit (A) and at least one particular aromatic unit (B).

The expression “comprises at least one unit (X)” is intended to mean that the polyester can comprise various types of units (X).

Thus, the tetrahydrofuran-dimethanol unit (A) can be a unit chosen from the units 2,5-tetrahydrofuran-dimethanol, 2,4-tetrahydrofuran-dimethanol, 2,3-tetrahydrofuran-dimethanol and 3,4-tetrahydrofuran-dimethanol or a mixture of these units.

Preferentially, it is a 2,5-tetrahydrofuran-dimethanol unit.

The 2,5-tetrahydrofuran-dimethanol unit is the following unit:

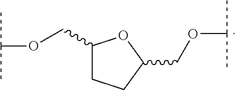

The polyester may also comprise a mixture of isomers of the diols mentioned above. For example, with regard to the 2,5-tetrahydrofuran-dimethanol unit, it may be, depending on its conformation, in the following isomeric forms:

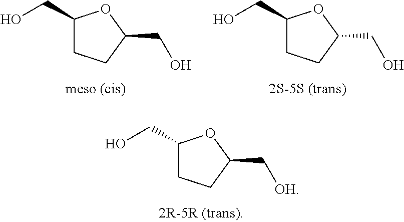 [SMILES: OC[C@@H]1CC[C@H](CO)O1 ; OC[C@@H]1CC[C@@H](CO)O1 ; OC[C@H]1CC[C@H](CO)O1]

When it is a mixture of isomers, it may be a mixture having a cis/trans ratio ranging from 1/99 to 99/1, for example from 90/10 to 99/1.

The tetrahydrofuran-dimethanol can be obtained by various reaction routes. It is preferably obtained at least partly from biobased resources. By way of example, the tetrahydrofuran-dimethanol can be obtained from diformylfuran as described in application WO 2014/049275 in the applicant's name.

The polyester also comprises an aromatic acid unit (B) which is chosen from the following units:

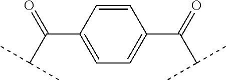

terephthalic acid;

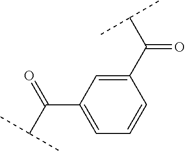

isophthalic acid;

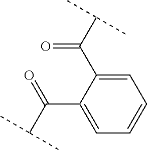

phthalic acid;

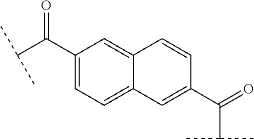

2,6-naphthalenedicarboxylic acid;

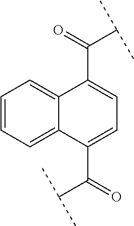

1,4-Naphthalenedicarboxylic acid;
or a mixture of these units, the dashed lines denoting the bonds by means of which the unit is connected to the rest of the polyester, this being irrespective of the monomer used to form said unit.

Quite obviously, from what is previously described, this means that the aromatic acid units of the polyester according to the invention can consist of terephthalic acid, isophthalic acid, phthalic acid, 2,6-naphthalenedicarboxylic acid and 1,4-naphthalenedicarboxylic acid units or a mixture of these acids. According to this preferred variant, the polyester according to the invention is essentially free, or even totally free, of other aromatic acid units. It is therefore, in this case, essentially free, or even totally free, of 2,5-furandicarboxylic acid units.

These various aromatic units have the common structural point of being units derived from monomers of diacid comprising aromatic rings comprising 6 carbon atoms.

Preferably, the aromatic unit (B) is a terephthalic acid unit. The polyester according to the invention may comprise at least one aliphatic diol unit (C) other than the diol (A).

According to this variant where the polyester also comprises at least one unit (C), the polyester according to the invention may in particular comprise, relative to the total amount of diol units (A) and (C):
from 1 to 99 units (A), advantageously from 5 to 95;
and from 1 to 99 units (C), advantageously from 5 to 95.

This aliphatic diol unit may comprise at least one unit chosen from linear aliphatic diols (C1), cycloaliphatic diols (C2), branched aliphatic diols (C3) or a mixture of these units.

According to a first advantageous embodiment, the aliphatic diol unit (C) is a linear aliphatic diol unit (C1) or a mixture of these units (C1).

The linear aliphatic diol unit (C1) has the following form:

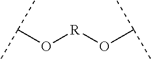

in which the R group is a linear aliphatic group, the dashed lines denoting the bonds by means of which the unit is connected to the rest of the polyester, this being irrespective of the monomer used to form said unit. Preferably, the R group is a saturated aliphatic group.

The diol (C1) is advantageously chosen from ethylene glycol, 1,3-propanediol, 1,4-butanediol, 1,5-pentanediol, 1,6-hexanediol, 1,8-octanediol, 1,10-decanediol, or a mixture of aliphatic diol units comprising at least one of these units, preferentially ethylene glycol and 1,4-butanediol, very preferentially ethylene glycol.

According to this first mode, the polyester according to the invention advantageously comprises, relative to the total amount of (A) and (C1):
from 1 to 99 units (A), advantageously from 5 to 90, preferentially from 20 to 80;
and from 1 to 99 units (C1), advantageously from 10 to 95, preferentially from 20 to 80.

According to a second advantageous embodiment, the aliphatic diol unit (C) is at least a cycloaliphatic diol unit (C2) or a mixture of these units (C2).

According to this second mode, the polyester according to the invention advantageously comprises, relative to the total amount of (A) and (C2):
from 1 to 99 units (A), advantageously from 5 to 98, preferentially from 80 to 95;
and from 1 to 99 units (C2), advantageously from 2 to 95, preferentially from 5 to 20.

According to a first sub-variant, the unit (C2) is chosen from the following units:

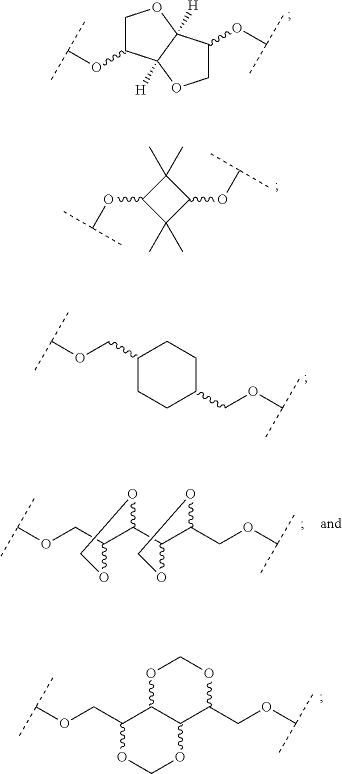

or a mixture of these units.

Advantageously, (C2) is a 1:4, 3:6-dianhydrohexitol unit chosen from:

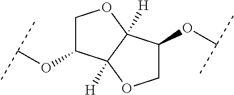

isosorbide;

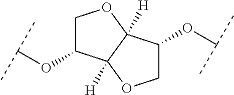

isomannide;

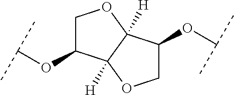

isoidide;
or a mixture of these units.

It is preferentially a unit:

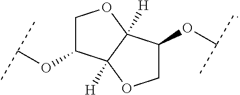

The isosorbide, isomannide and isoidide can thus be obtained respectively by dehydration of sorbitol, of mannitol and of iditol.

The synthesis of these dianhydrohexitols is well-known: various routes are described for example in the articles by Fletcher et al. (1,4,3,6-Hexitol dianhydride, l-isoidide, J Am Chem Soc, 1945, 67:1042-3 and also 1,4,3,6-Dianhydro-l-iditol and the structure of isomannide and isosorbide, J Am Chem Soc, 1946, 68:939-41), by Montgomery et al. (Anhydrides of polyhydric alcohols. IV. Constitution of dianhydrosorbitol, J Chem Soc, 1946, 390-3 & Anhydrides of polyhydric alcohols. IX. Derivatives of 1,4-anhydrosorbitol from 1,4,3,6-dianhydrosorbitol, J Chem Soc, 1948, 237-41), by Fleche et al. (Isosorbide. Preparation, properties and chemistry, Starch/Staerke 1986, 38:26-30), and by Fukuoka et al. (Catalytic conversion of cellulose into sugar Alcohols, Angew Chem Int Ed, 2006, 45:5161-3), and in U.S. Pat. No. 3,023,223.

The unit (C2) may also be a cyclobutanediol unit, for example a tetramethylcyclobutanediol unit, in particular a unit chosen from:

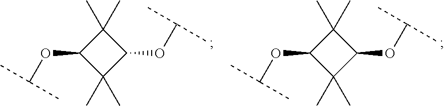

or a mixture of these units.

The unit (C2) may also be a cyclohexanedimethanol unit, in particular a unit chosen from the units 1,4-cyclohexanedimethanol, 1,2-cyclohexanedimethanol and 1,3-cyclohexanedimethanol or a mixture of these diols and of isomers of these diols. These diols may be in the cis or trans configuration. For example, in the case of a 1,4-cyclohexanedimethanol unit, they are units:

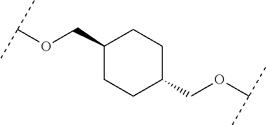

for the cis configuration;

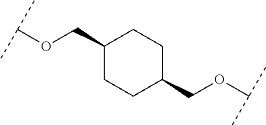

for the trans configuration;

The unit (C2) may also be chosen from:

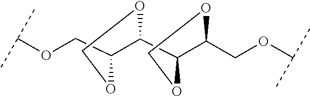

2,3:4,5-di-O-methylene-galactitol;

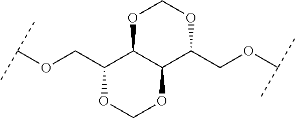

2,4:3,5-di-O-methylene-D-mannitol;

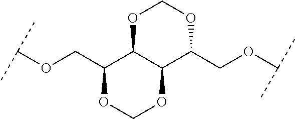

2,4:3,5-di-O-methylene-D-glucitol;
   or a mixture of these units.

The 2,3:4,5-di-O-methylene-galactitol can for its part be obtained by acetalization then reduction of galactaric acid, as described by Lavilla et al. in Bio-based poly(butylene terephthalate) copolyesters containing bicyclic diacetalized galactitol and galactaric acid: Influence of composition on properties, Polymer, 2012, 53(16), 3432-3445. The 2,4:3,5-di-O-methylene-D-mannitol can for its part be obtained by acetalization of D-mannitol with formaldehyde, as described by Lavilla et al. in Bio-Based Aromatic Polyesters from a Novel Bicyclic Diol Derived from D-Mannitol, Macromolecules, 2012, 45, 8257-8266.

According to the invention, the polyester may comprise mixtures of units (C2) as described in the previous two sub-variants.

According to the invention, the polyester may comprise mixtures of units (C2) as described in the previous two sub-variants.

According to a third advantageous embodiment, the aliphatic diol unit (C) is at least one mixture of at least one linear aliphatic diol unit (C1) and of at least one cycloaliphatic diol unit (C2).

The diols (C1) and (C2) can be chosen from those previously listed.

The polyester according to the invention advantageously comprises, relative to the total amount of (A) and (C):
from 1 to 98 units (A), advantageously from 5 to 90, preferentially from 20 to 85;
from 1 to 98 units (C1), advantageously from 5 to 60, preferentially from 5 to 40;
and from 1 to 98 units (C2), advantageously from 5 to 60, preferentially from 5 to 40.

In the case where the polyester comprises units (C3), the branched aliphatic diol unit has the following form:

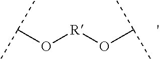

in which the R′ group is a branched aliphatic group, the dashed lines denoting the bonds by means of which the unit is connected to the rest of the polyester, this being irrespective of the monomer used to form said unit. Preferably, the R′ group is a saturated group.

The polyester according to the invention may comprise additional monomeric units other than the units (A), (B) and optional (C). Preferably, the amount of additional monomeric units is, relative to the total sum of the units of the polyester, less than 30%, most preferentially less than 10%. The polyester according to the invention may be free of additional monomeric unit.

The additional monomeric units may in particular be diether units such as diethylene glycol units. These diether units can originate from co-products of the polymerization process, i.e. they can originate for example from an etherification reaction between two glycols. In order to limit this etherification reaction, it is possible to add to the reactor a base that limits this phenomenon, said base possibly being sodium acetate, sodium hydroxide, tetramethylammonium hydroxide, tetraethylammonium hydroxide or a mixture of these bases. Preferably, the amount of diether units is, relative to the total sum of the units of the polyester, less than 10%. The polyester according to the invention may be free of diether unit.

The additional monomeric units may also be additional diacid units other than the aromatic units (B). By way of example, these units may be saturated aliphatic diacid units. As saturated cyclic aliphatic diacid unit, mention may be made of the 1,4-cyclohexanedioic acid unit. Advantageously, the aliphatic diacid unit is a linear saturated aliphatic diacid unit. These units may be chosen from succinic acid, glutaric acid, adipic acid, pimelic acid, suberic acid, azelaic acid and sebacic acid units or a mixture of these diacids. Preferably, the aliphatic diacid is chosen from succinic acid and adipic acid, most preferentially from succinic acid. Preferably, the amount of additional diacid units is, relative to the total sum of the units of the polyester, less than 30%, most preferentially less than 10%. The polyester according to the invention may be free of additional diacid unit.

The additional monomeric units may also be hydroxy acid units. By way of example, the hydroxy acid units may be glycolic acid, lactic acid, hydroxybutyric acid, hydroxycaproic acid, hydroxyvaleric acid, 7-hydroxyheptanoic acid, 8-hydroxyoctanoic acid, 9-hydroxynonanoic acid, hydroxymethylfurancarboxylic acid and hydroxybenzoic acid units or a mixture of these hydroxy acids. With regard to these hydroxy acid units, they are capable of being obtained from a hydroxy acid or from a dilactone such as glycolide or lactide. Preferably, the amount of hydroxy acid units is, relative to the total sum of the units of the polyester, less than 10%. The polyester according to the invention may be free of hydroxy acid unit.

The polyester according to the invention may also comprise chain extender units. The term “chain extender” unit is intended to mean a unit capable of being obtained using a monomer comprising two functions other than the hydroxyl, carboxylic acid and carboxylic acid ester functions, and capable of reacting with these same functions. The functions may be isocyanate, isocyanurate, caprolactam, caprolactone, carbonate, epoxy, oxazoline and imide functions, it being possible for said functions to be identical or different. By way of chain extenders that can be used in the present invention, mention may be made of:
diisocyanates, preferably methylenediphenyl diisocyanate (MDI), isophorone diisocyanate (IPDI), dicyclohexylmethane diisocyanate (H12MDI), toluene diisocyanate (TDI), naphthalene diisocyanate (NDI), hexamethylene diisocyanate (HMDI) or lysine diisocyanate (LDI), the aliphatic diisocyanate having a molar mass of 600 g/mol obtained from fatty diacid dimers (DDI®1410 Diisocyanate),
diisocyanate dimers, trimers and tetramers,
prepolymers termed “isocyanate-free” resulting from a reaction of a diol or of an amine with a diisocyanate under conditions such that the prepolymer contains an isocyanate function at each of its ends (α,ω-functional or telechelic polymer) without it being possible for free diisocyanate to be detected,
dialkyl carbonates, in particular dianhydrohexitol dialkyl carbonates, and in particular isosorbide dialkyl carbonates,
dicarbamoylcaprolactams, preferably 1,1′-carbonyl-bis-caprolactam, dicarbamoylcaprolactones,
diepoxides,
compounds comprising an epoxide function and a halide function, preferably epichlorohydrin,
heterocyclic compounds, preferably bis-oxazolines, bis-oxazolin-5-ones and bis-azalactones,
methylenic or ethylenic diester derivatives, preferably methyl or ethyl carbonate derivatives,
any mixtures of at least any two of the abovementioned products.

Preferably, the amount of chain extender units is, relative to the total sum of the units of the polyester, less than 10%. The polyester according to the invention may be free of chain extender unit.

The monomeric units may also be polyfunctional units. The term “polyfunctional unit” is intended to mean a unit which can be obtained by reaction of a comonomer capable of reacting with the hydroxide and/or carboxylic acid and/or carboxylic acid ester functions and the functionality of which is greater than 2. The reactive functions of these branching agents may be hydroxide, carboxylic acid, anhydride, isocyanate, isocyanurate, caprolactam, caprolactone, carbonate, epoxy, oxazoline and imide functions, it being possible for said functions to be identical or different, preferably carboxylic acid, hydroxide, epoxide or isocyanate functions, most preferentially carboxylic acid or hydroxide functions. The functionality of these branching agents may be from 3 to 6, preferably from 3 to 4. Among the branching agents conventionally used, mention may be made of: malic acid, citric acid or isocitric acid, tartaric acid, trimesic acid, tricarballylic acid, cyclopentanetetracarboxylic acid, trimellitic anhydride, pyromellitic monoanhydride or dianhydride, glycerol, pentaerythritol, dipentaerythritol, monoanhydrosorbitol, monoanhydromannitol, epoxide oils, dihydroxystearic acid, trimethylolpropane, ethers of these polyols, for instance glyceryl propoxylate (sold under the name Voranol 450 by Dow Chemical), polymers which have epoxide side functions, triisocyanates, tetraisocyanates and also the respective homopolymers of di-, tri- and tetraisocyanates that exist, polyanhydrides, and alkoxysilanes, preferably tetraethoxysilane.

Preferably, the amount of polyfunctional units is, relative to the total sum of the units of the polyester, less than 10%. The polyester according to the invention may be free of polyfunctional unit.

According to another mode of the invention, the polyester according to the invention comprises, relative to the total amount of the units:
from 5% to 55% of units (A);
from 40% to 60% of units (B);
from 0% to 50% of units (C);
from 0% to 10% of diether units;
from 0% to 30% of additional diacid units other than (B), preferentially from 0% to 10%;
from 0% to 10% of hydroxy acid units;
from 0% to 10% of chain extender units;
from 0% to 10% of polyfunctional units.

The polyester according to the invention may be partially biobased, or even totally biobased. In other words, it is partly or totally obtained from monomers that are at least partially biobased.

The polyester may be a random copolymer or a block copolymer.

Preferably, the polyester according to the invention is characterized in that the molar ratio of units (B)/((A)+optional(C)) ranges from 60/40 to 40/60, advantageously from 55/45 to 45/55.

The amounts of various units in the polyester can be determined by ¹H NMR.

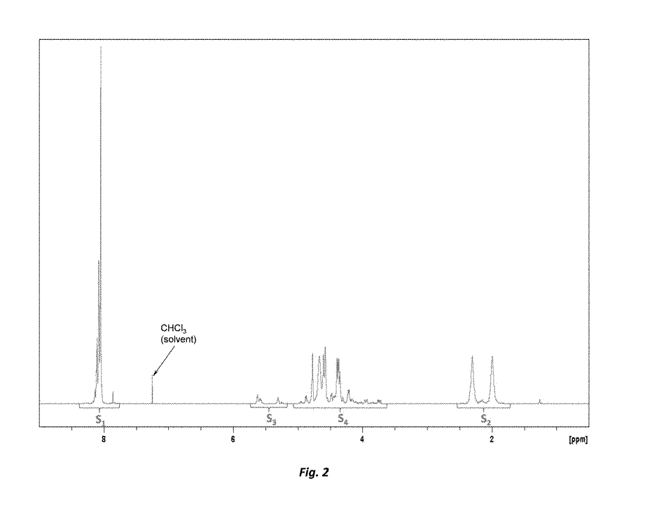

Those skilled in the art can easily find the analysis conditions for determining the amounts of each of the units of the polyester. For example, FIG. 2 presents the NMR spectrum of a poly(ethylene-co-isosorbide-co-tetrahydrofuran-dimethanol terephthalate). The chemical shifts relating to ethylene glycol are between 4.4 and 5.0 ppm, the chemical shifts relating to the terephthalate ring are between 7.8 and 8.2 ppm, the chemical shifts relating to tetrahydrofuran-dimethanol are between 3.6 and 5.0 ppm and between 1.8 and 2.4 ppm and the chemical shifts relating to isosorbide are around 4.2 ppm, 4.8 ppm, 5.2 ppm and 5.6 ppm. The integration of each signal makes it possible to determine the amount of each unit of the polyester.

Preferably, the polyester has a weight-average molar mass of greater than 7500 g/mol, preferably greater than 10 000 g/mol, most preferentially greater than 20 000 g/mol.

The molar mass of the polyester can be determined by conventional methods, for instance by size-exclusion chromatography (SEC) in a mixture of chloroform and 1,1,1,3,3,3-hexafluoro-2-propanol in a 98/2 volume ratio. The signal can then be detected by a differential refractometer calibrated with poly(methyl methacrylate) standards.

Preferably, the glass transition temperature of the polymer according to the invention is greater than or equal to 55° C., or even greater than 60° C. The glass transition temperature of the polyester can be measured by conventional methods, in particular using differential scanning calorimetry (DSC) using a heating rate of 10 K/min. The experimental protocol is described in detail in the examples section hereinafter.

Advantageously, the polyester according to the invention has a glass transition temperature of less than or equal to 85° C., for example less than or equal to 80° C., in particular less than or equal to 75° C. This makes it possible to transform the polymer at a lower temperature than a PET or a PETg.

The polyester, which is the subject of the invention, may be semicrystalline or amorphous. Advantageously, the polyester has a degree of crystallinity of less than 50%, preferentially less than 35%. The crystallinity of the polyester can be determined by DSC by heating a sample from 10 to 280° C. (10 K/min), then cooling to 10° C. (10 K/min). Preferably, the polyester according to the invention is amorphous; in other words, its crystallinity is zero. In this case, it has an improved impact resistance and improved optical properties, this being without requiring the use of a specific impact modifier or of a clarifying agent.

The invention also relates to a process for producing thermoplastic polyester, which comprises:
a step of introducing, into a reactor, monomers comprising at least one tetrahydrofuran-dimethanol diol (A), at least one aromatic acid (B) chosen from terephthalic acid, isophthalic acid, phthalic acid, 2,6-naphthalenedicarboxylic acid and 1,4-naphthalenedicarboxylic acid and/or a diester of this acid and optionally at least one aliphatic diol (C) other than the diol (A); and
a step of polymerizing the monomers so as to form the polyester, comprising:
   a first stage during which the reaction medium is stirred at a temperature ranging from 140 to 250° C. in order to form oligomers;
   a second stage during which the oligomers formed are stirred under vacuum, at a temperature ranging from 230 to 310° C. in order to form the polyester;
a step of recovering the polyester at the end of the polymerizing step.

Using this process, it is possible to obtain a polyester which has a glass transition temperature sufficient to be able to be used as a plastic for the production of objects of any type.

The various monomers mentioned above can be used to carry out the process according to the invention.

With regard to the monomers introduced into the reactor, they can be introduced into the reactor all at once or in several steps, in the form of a mixture or separately.

The diols (A) and (C) that are of use in the process of the invention have been described above in the corresponding polyester unit parts.

With regard to the diacid units, including the units (B), they can be obtained from the diacid, but it is also possible to replace this diacid with monomers that differ only in that the carboxylic acid function of the monomer is replaced with a carboxylic acid ester function. By way of example, alkyl terephthalate can be used to form the terephthalic acid unit. Preferably, the dicarboxylic acid alkyl diesters, and in particular those mentioned, are methyl or ethyl, most preferentially methyl, diesters. In the case of the phthalic acid unit, it can also be obtained via the phthalic anhydride.

With regard to the additional monomeric units, they can be obtained from the monomers mentioned as units of the polyester. In the case of units bearing acid functions, they can be obtained via monomers that differ from the mentioned monomers only in that the carboxylic acid function of the monomer is replaced with a carboxylic acid ester function or optionally, when these monomers exist, with an anhydride function.

Preferably, the process as claimed in the preceding claim, characterized in that, relative to the total moles of monomers (A), (B) and optional (C) introduced into the reactor, the molar percentage of acid and/or of diester (B) ranges from 25% to 45%.

Indeed, in the process according to the invention, an excess of diol is preferably used in order to carry out the synthesis of the polyester. This makes it possible to accelerate the reaction and also to increase the final molar mass of the polyester thus formed.

Those skilled in the art will be able to adjust the amounts of diol (A) and (C) introduced into the reactor in order to obtain the respective proportions in the various diols of the polyesters according to the invention previously described. Relative to the total moles of diol (A) and (C), at least 1 mol % and at most 99 mol % consist of diol (A), in particular from 5 to 98%.

Preferably, the temperature during the first stage of polymerization ranges from 150 to 200° C. Preferably, this first stage is carried out in an inert gas atmosphere, this gas possibly in particular being dinitrogen. This first stage can be carried out under a gas stream. It can also be carried out under pressure, for example at a pressure of between 1.05 and 8 bar. Preferably, when the monomer (B) is of acid type, the pressure ranges from 3 to 8 bar. Preferably, when the monomer (B) is of ester type, the pressure ranges from 1.05 to 3 bar.

Prior to the first stage of polymerization, a reactor deoxygenation step is preferentially carried out. It can be carried out for example by producing a vacuum in the reactor and then by introducing an inert gas such as nitrogen into the reactor. This vacuum-inert gas introduction cycle can be repeated several times, for example from 3 to 5 times. Preferably, this vacuum-nitrogen cycle is carried out at a temperature between 60 and 80° C. so that the reagents, and in particular the bicyclic diols, are totally molten. This deoxygenation step has the advantage of improving the coloration properties of the polyester obtained at the end of the process.

Preferably, the temperature during the second stage of polymerization ranges from 260 to 300° C.

This second stage is carried out under vacuum, preferably at a pressure below 10 mbar, most preferentially below 1 mbar.

According to the invention, the first stage of the polymerization step preferably has a duration ranging from 1 to 5 hours. Advantageously, the second stage has a duration ranging from 2 to 6 hours.

The process according to the invention comprises a step of polymerization in the presence of a catalyst.

A transesterification catalyst is advantageously used during this stage. This transesterification catalyst can be chosen from tin derivatives, preferentially tin(IV) derivatives, titanium derivatives, zirconium derivatives, hafnium derivatives, zinc derivatives, manganese derivatives, calcium derivatives and strontium derivatives, organic catalysts such as para-toluenesulfonic acid (PTSA) or methanesulfonic acid (MSA), or a mixture of these catalysts. By way of example of such compounds, mention may be made of those given in application US 2011282020A1 in paragraphs [0026] to [0029], and on page 5 of application WO 2013/062408 A1.

Preferably, a tin IV derivative, a titanium derivative, a zinc derivative or a manganese derivative is used during the first stage of transesterification.

At the end of transesterification, the catalyst of the first stage can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011 282020A1.

The second stage of polymerization (polycondensation) can optionally be carried out with the addition of an additional catalyst. This catalyst is advantageously chosen from tin derivatives, preferentially tin(II) derivatives, and derivatives of tin, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 B1 in paragraphs [0090] to [0094].

Preferably, the catalyst is a tin(II), titanium, germanium or antimony derivative.

Most preferentially, during the first stage and the second stage of polymerization, a titanium-based catalyst is used.

The polyester recovered during the final step of the process advantageously has the characteristics given above.

The process according to the invention comprises a step of recovering the polyester resulting from the polymerization step. The polyester can be recovered by extracting it from the reactor in the form of a molten polymer rod. This rod can be converted into granules using conventional granulation techniques.

The process according to the invention can also comprise, after the polyester recovery step, a step of polymerization in the solid state.

A subject of the invention is also a polyester that can be obtained according to the process of the invention.

The invention also relates to a composition comprising the polyester according to the invention and at least one additive or at least one additional polymer or at least a mixture thereof.

Thus, the composition according to the invention can also comprise, as additive, fillers or fibers of organic or inorganic nature, which are optionally nanometric and optionally functionalized. They may be silicas, zeolites, glass fibers or beads, clays, mica, titanates, silicates, graphite, calcium carbonate, calcium nanotubes, wood fibers, carbon fibers, polymer fibers, proteins, cellulose-based fibers, lignocellulosic fibers and non-destructured granular starch. These fillers or fibers can make it possible to improve the hardness, the rigidity or the water- or gas-permeability. The composition may comprise from 0.1% to 75% by weight of fillers and/or fibers relative to the total weight of the composition, for example from 0.5% to 50%. The composition may also be of composite type, i.e. may comprise large amounts of these fillers and/or fibers.

The additive that is of use in the composition according to the invention may also comprise opacifiers, dyes and pigments. They may be chosen from cobalt acetate and the following compounds: HS-325 Sandoplast® Red BB (which is a compound bearing an azo function, also known under the name Solvent Red 195), HS-510 Sandoplast® Blue 2B which is an anthraquinone, Polysynthren® Blue R, and Clariant® RSB Violet.

The composition may also comprise, as additive, a processing aid, for reducing the pressure in the processing tool. A demolding agent which makes it possible to reduce adhesion to the materials for forming the polyester, such as the molds and the calendering rolls, can also be used. These agents can be selected from fatty acid esters and fatty acid amides, metal salts, soaps, paraffins or hydrocarbon-based waxes. Particular examples of these agents are zinc stearate, calcium stearate, aluminum stearate, stearamide, erucamide, behenamide, beeswaxes or candelilla wax.

The composition according to the invention may also comprise other additives, such as stabilizers, for example light stabilizers, UV-stabilizers and heat stabilizers, fluidizing agents, flame retardants and antistatics. It may also comprise primary and/or secondary antioxidants.

The primary antioxidant may be a sterically hindered phenol, such as the compounds Hostanox® 0 3, Hostanox® 0 10, Hostanox® 0 16, Ultranox® 210, Ultranox®276, Dovernox® 10, Dovernox® 76, Dovernox® 3114, Irganox® 1010 or Irganox® 1076. The secondary antioxidant may be trivalent phosphorus compounds such as Ultranox® 626, Doverphos® S-9228, Hostanox® P-EPQ or Irgafos 168.

The composition may also comprise an additional polymer, different than the polyester according to the invention. This polymer may be chosen from polyamides, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s, such as poly(2,6-dimethylphenylene oxide), poly(phenylene sulfate)s, poly(ester-carbonate)s, polycarbonates, polysulfones, polysulfone ethers, polyether ketones, and mixtures of these polymers.

The composition may also comprise, as additional polymer, a polymer which makes it possible to improve the impact properties of the polymer, in particular functional polyolefins such as functionalized ethylene or propylene polymers and copolymers, core-shell copolymers or block copolymers.

The composition according to the invention may also comprise polymers of natural origin, such as starch, cellulose, chitosans, alginates, proteins such as gluten, pea proteins, casein, collagen, gelatin or lignin, it being possible for these polymers of natural origin to optionally be physically or chemically modified. The starch can be used in destructured or plasticized form. In the latter case, the plasticizer may be water or a polyol, in particular glycerol, polyglycerol, isosorbide, sorbitan, sorbitol, mannitol or else urea. The process described in document WO 2010/010282 A1 may in particular be used to prepare the composition.

The composition according to the invention may be produced by conventional thermoplastic transformation methods. These conventional methods comprise at least one step of mixing in the molten or softened state of the polymers and a step of recovering the composition. This process may be performed in paddle or rotor internal mixers, external mixers, or single-screw or twin-screw corotating or counter-rotating extruders. However, it is preferred to prepare this mixture by extrusion, in particular using a corotating extruder.

The mixing of the constituents of the composition can be carried out under an inert atmosphere.

In the case of an extruder, the various constituents of the composition may be introduced by means of feed hoppers located along the extruder.

The invention also relates to an article comprising the polyester or the composition according to the invention.

This article may be of any type and may be obtained using conventional transformation techniques.

It may be, for example, fibers or threads that are of use in the textile industry or other industries. These fibers or threads may be woven so as to form fabrics, or else nonwovens.

The article according to the invention may also be a film or a sheet. These films or sheets may be produced by calendering, film cast extrusion or blown film extrusion techniques.

The article according to the invention may also be a container for transporting gases, liquids and/or solids. The containers concerned may be babies bottles, flasks, bottles, for example sparkling or still water bottles, juice bottles, soda bottles, carboys, alcoholic drink bottles, small bottles, for example small medicine bottles, small bottles for cosmetic products, dishes, for example for ready meals, microwave dishes, or else lids. These containers may be of any size. They may be produced by extrusion-blow molding, thermoforming or injection-blow molding.

These articles may also be optical articles, i.e. articles requiring good optical properties, such as lenses, disks, transparent or translucent panels, optical fibers, films for LCD screens or else window panes. These optical articles have the advantage that they can be placed close to light sources and therefore to heat sources, while retaining excellent dimensional stability and good resistance to light.

The articles may also be multilayer articles, at least one layer of which comprises the polymer or the composition according to the invention. These articles may be produced via a process comprising a step of coextrusion in the case where the materials of the various layers are placed in contact in the molten state. By way of example, mention may be made of the techniques of tube coextrusion, profile coextrusion, coextrusion blow-molding of a bottle, a small bottle or a tank, generally collated under the term “coextrusion blow-molding of hollow bodies, coextrusion blow-molding also known as film blowing, and cast coextrusion.

They may also be produced according to a process comprising a step of applying a layer of molten polyester onto a layer based on organic polymer, metal or adhesive composition in the solid state. This step may be performed by pressing, by overmolding, by lamination, extrusion-lamination, coating, extrusion-coating or spreading.

The invention will now be illustrated in the examples hereinafter. It is specified that these examples do not in any way limit the present invention.

### Examples

### Reagents

For the illustrative examples presented below, the following reagents were used:

### Monomer (A):

2,5-tetrahydrofuran-dimethanol (THFDM) (purity 99.6%). Obtained by hydrogenation of 2,5-furan-dimethanol (95%, Pennakem) on Raney Ni at 110° C. and 70 bar, then purification by distillation.

### Monomer (B):

Dimethyl terephthalate (99%) from Acros Organics

### Monomer (C):

Ethylene glycol (purity >99.8%) from Sigma-Aldrich

Isosorbide (purity >99.5%) Polysorb® P from Roquette Fréres

2,2,4,4-tetramethyl-1,3-cyclobutanediol (purity >98%) from Chemical Point, cis/trans ratio=50/50

### Catalyst:

Titanium isopropoxide (>99.99%) from Sigma-Aldrich

### Analytical Techniques

### NMR

The ¹H NMR analysis of the polyester samples was carried out using a Brucker 400 MHz spectrometer equipped with a QNP probe. Prior to the analysis, 15 mg of the polyester sample were dissolved in 0.6 ml of deuterated chloroform (CDCl₃) and 0.1 ml of tetrafluoroacetic acid (d1-TFA). Integration of the peaks corresponding to the various units in particular made it possible to calculate the A/C and A/C1/C2 ratios given in tables 1 and 2.

### Size-Exclusion Chromatography

The molar mass of the polymer was evaluated by size-exclusion chromatography (SEC) in a mixture of chloroform and 1,1,1,3,3,3-hexafluoro-2-propanol (98:2 vol %). The polyester samples were dissolved at a concentration of 1 and were then eluted at a flow rate of 0.75 ml.min⁻¹. The signal acquisition was carried out using a refractometric detector (Agilent RI-1100a) and the weight-average molar masses (Mw) were subsequently evaluated using poly(methyl methacrylate) (PMMA) standards.

### DSC

The thermal properties of the polyesters were measured by differential scanning calorimetry (DSC): The sample is first of all heated from 10 to 280° C. (10° C.min⁻¹), cooled to 10° C. (10° C.min⁻¹) and then reheated to 280° C. under the same conditions as the first step. The glass transition was taken at the mid-point of the second heating.

### Preparation and Characterization of Thermoplastic Polyesters

In the protocols which follow, the parts of reagents are given in proportions by weight.

### Example According to the Invention (Ex. 1)

50 g of dimethyl terephthalate, 29.61 g of ethylene glycol, 1.64 g of tetrahydrofuran-dimethanol (cis/trans ratio: 95/5) and 59 mg of titanium isopropoxide are placed in a reactor. The mixture is stirred by mechanical stirring at 150 rpm and is placed in an oven heated to 180° C. over the course of 15 min under a nitrogen stream. Still under a nitrogen stream, the oven is then maintained at 180° C. for 1 h, before being again heated to 210° C. over the course of 1 hour. This temperature is maintained for 2 h in order to remove the maximum amount of methanol.

Following this, the oven temperature is increased to 290° C., the pressure is reduced over the course of 90 min to 0.7 mbar and the stirring speed is reduced to 50 rpm. These conditions will be maintained for 3 h.

The characteristics of the polymer formed are reported in table 1 below.

### Example According to the Invention (Ex. 2)

50 g of dimethyl terephthalate, 28.85 g of ethylene glycol, 3.28 g of tetrahydrofuran-dimethanol (cis/trans ratio: 95/5) and 60 mg of titanium isopropoxide are placed in a reactor. The mixture is stirred by mechanical stirring at 150 rpm and is placed in an oven heated to 180° C. over the course of 15 min under a nitrogen stream. Still under a nitrogen stream, the oven is then maintained at 180° C. for 1 h, before being again heated to 210° C. over the course of 1 hour. This temperature is maintained for 2 h in order to remove the maximum amount of methanol.

Following this, the oven temperature is increased to 290° C., the pressure is reduced over the course of 90 min to 0.7 mbar and the stirring speed is reduced to 50 rpm. These conditions will be maintained for 3 h.

The characteristics of the polymer formed are reported in table 1 below.

### Example According to the Invention (Ex. 3)

50 parts of dimethyl terephthalate, 21.2 parts of ethylene glycol, 10.4 parts of tetrahydrofuran-dimethanol, and 8.2 parts of a solution of titanium isopropoxide in toluene (1% by weight of titanium isopropoxide) are placed in a reactor. The mixture is stirred by mechanical stirring at 150 rpm and is placed in an oven heated to 180° C. over the course of 15 min under a nitrogen stream. Still under a nitrogen stream, the oven is then maintained at 180° C. for 1 h, before being again heated to 210° C. over the course of 1 h. This temperature is maintained for 2 h in order to remove the maximum amount of methanol.

Following this, the oven temperature is increased to 290° C., the pressure is reduced over the course of 90 min to 0.7 mbar and the stirring speed is reduced to 50 rpm. These conditions are maintained for 3 h.

The characteristics of the polymer formed are reported in table 1 below.

### Example According to the Invention (Ex. 4)

50 parts of dimethyl terephthalate, 27 parts of ethylene glycol, 12 parts of tetrahydrofuran-dimethanol and 6.3 parts of a solution of titanium isopropoxide in toluene (1% by weight of titanium isopropoxide) are placed in a reactor. The mixture is stirred by mechanical stirring and is heated to 160° C. over the course of 30 min under a nitrogen stream. Still under a nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 270° C., and the pressure is reduced over the course of 90 min to 0.7 mbar with magnetic stirring. These conditions are maintained for 3 h.

The characteristics of the polymer formed are reported in table 1 below.

### Example According to the Invention (Ex. 5)

49 parts of dimethyl terephthalate, 12 parts of ethylene glycol, 42 parts of tetrahydrofuran-dimethanol, and 7.2 parts of a solution of titanium isopropoxide in toluene (1% by weight of titanium isopropoxide) are placed in a reactor. The mixture is stirred by mechanical stirring and is heated to 160° C. over the course of 30 min under a nitrogen stream. Still under a nitrogen stream, the mixture is then maintained at 160° C. for 1 h, before being again heated to 190° C. over the course of ½ h. This temperature is maintained for 2 h in order to remove the maximum amount of methanol.

Following this, the reactor temperature is increased to 270° C., and the pressure is reduced over the course of 90 min to 0.7 mbar with magnetic stirring. These conditions are maintained for 3 h.

The characteristics of the polymer formed are reported in table 1 below.

### Example According to the Invention (Ex. 6)

51 parts of dimethyl terephthalate, 22 parts of ethylene glycol, 21 parts of tetrahydrofuran-dimethanol and 6.8 parts of a solution of titanium isopropoxide in toluene (1% by weight of titanium isopropoxide) are placed in a reactor. The mixture is stirred by mechanical stirring and is heated to 160° C. over the course of 30 min under a nitrogen stream. Still under a nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 270° C., and the pressure is reduced over the course of 90 min to 0.7 mbar with magnetic stirring. These conditions are maintained for 3 h.

The characteristics of the polymer formed are reported in table 1 below.

### Example According to the Invention (Ex. 7)

51 parts of dimethyl terephthalate, 20 parts of ethylene glycol, 31 parts of tetrahydrofuran-dimethanol, and 6.0 parts of a solution of titanium isopropoxide in toluene (1% by weight of titanium isopropoxide) are placed in a reactor. The mixture is stirred by mechanical stirring and is heated to 160° C. over the course of 30 min under a nitrogen stream. Still under a nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 270° C., and the pressure is reduced over the course of 90 min to 0.7 mbar with magnetic stirring. These conditions are maintained for 3 h.

The characteristics of the polymer formed are reported in table 1 below.

### Example According to the Invention (Ex. 8)

25 parts of dimethyl terephthalate, 32.8 parts of tetrahydrofuran-dimethanol and 3.9 parts of a solution of titanium isopropoxide in toluene (1% by weight of titanium isopropoxide) are placed in a reactor. The mixture is stirred by mechanical stirring at 150 rpm and placed in an oven heated to 210° C. over the course of 15 min under a nitrogen stream. Still under a nitrogen stream, the oven is then maintained at 210° C. for 30 min, before being again heated to 255° C. over the course of 30 min. This temperature is maintained for 2 h in order to remove the maximum amount of methanol.

Following this, the oven temperature is increased to 290° C., the pressure is reduced over the course of 60 min to 0.7 mbar and the stirring speed is reduced to 50 rpm. These conditions are maintained for 3 h.

The characteristics of the polymer formed are reported in table 1 below.

### Comparative Example (CP)

50 g of dimethyl terephthalate, 32.0 g ethylene glycol and 7.1 parts of a solution of titanium isopropoxide in toluene (1% by weight of titanium isopropoxide) are placed in a reactor. The mixture is stirred by mechanical stirring at 150 rpm and is placed in an oven heated to 180° C. over the course of 15 min under a nitrogen stream. Still under a nitrogen stream, the oven is then maintained at 180° C. for 1 h, before being again heated to 210° C. over the course of 1 h. This temperature is maintained for 2 h in order to remove the maximum amount of methanol.

Following this, the oven temperature is increased to 290° C., the pressure is reduced over the course of 90 min to 0.7 mbar and the stirring speed is reduced to 50 rpm. These conditions are maintained for 3 h.

The characteristics of the polymer formed are reported in table 1 below.

TABLE 1
Properties of the polyesters according to the invention and comparative
polyesters: effect of tetrahydrofuran on polyesters of poly(ethylene-
co-tetrahydrofuran-dimethanol terephthalate) type

| Exam- | Tm (° C.) or | Tg | (A/C) | Mw |
|---|---|---|---|---|
| ples | amorphous | (° C.) | (mol/mol) | (g/mol) |
| 1 | 247 (degree of | 77 | 3.4/96.6 | NM |
| | crystallinity of 41%) | | | |
| 2 | 240 (degree of | 76 | 7.4/92.6 | NM |
| | crystallinity of 33%) | | | |
| 3 | Amorphous | 74 | 24.8/75.2 | 66 200 |
| 4 | Amorphous | 60 | 39.4/60.6 | 28 050 |
| 5 | Amorphous | 61 | NM | NM |
| 6 | Amorphous | 55 | 61.2/38.8 | 25 500 |
| 7 | Amorphous | 57 | 70.4/29.6 | 29 800 |
| 8 | Amorphous | 57 | 100/0 | 5350 |
| CP | 254 (degree of | 80 | 0/100 | 29 100 |
| | crystallinity of 50%) | | | |

NM: Not measured

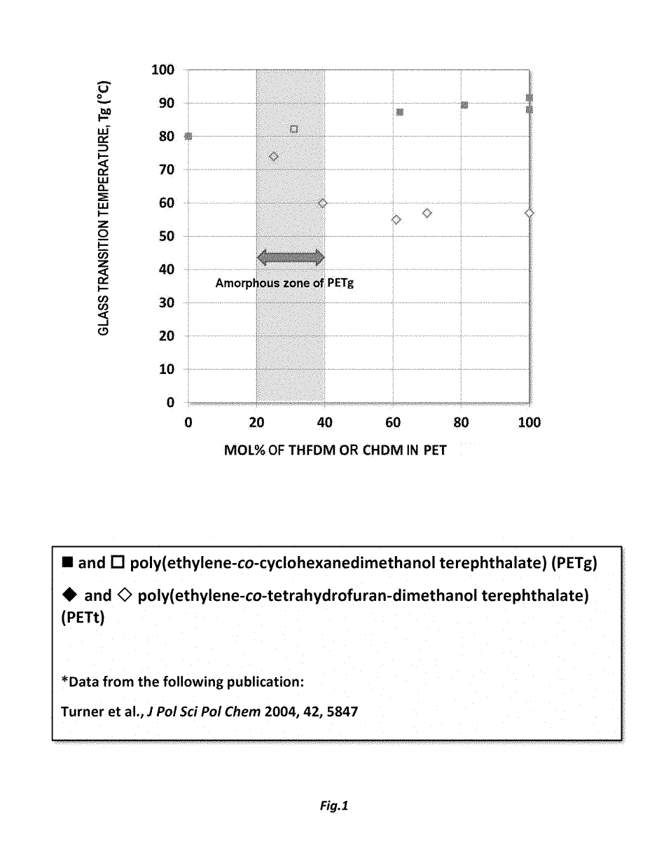

These tests show that the amorphous range of the polyesters according to the invention is much more extended than that of the polymers comprising CHDM, such as those described in the publication by Turner et al. already mentioned (see also FIG. 1).

Thus, contrary to the polyesters produced from CHDM, it is possible to obtain, using the polyester according to the invention, a polyester which has a lower glass transition temperature, thereby making it possible for it to be transformable at a lower temperature.

This glass transition temperature is lower than that of PET, but the polyester according to the invention remains entirely satisfactory for numerous applications.

Moreover, as soon as small amounts of THFDM are introduced, it is possible to considerably decrease the crystallinity of the polyester obtained (see examples 1 and 2 in comparison with example CP).

### Example According to the Invention (Ex. 9)

51 parts of dimethyl terephthalate, 11 parts of ethylene glycol, 34 parts of tetrahydrofuran-dimethanol, 9 parts of isosorbide and 7.3 parts of a solution of titanium isopropoxide in toluene (1% by weight of titanium isopropoxide) are placed in a reactor. The mixture is stirred by mechanical stirring and is heated to 160° C. over the course of 30 min under a nitrogen stream. Still under a nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 270° C., and the pressure is reduced over the course of 90 min to 0.7 mbar with magnetic stirring. These conditions are maintained for 3 h.

The polymer obtained is an amorphous polymer, the properties of which are reported in table 2 below.

### Example According to the Invention (Ex. 10)

50 parts of dimethyl terephthalate, 12.1 parts of ethylene glycol, 34.6 parts of tetrahydrofuran-dimethanol, 9 parts of isosorbide and 7.3 parts of a solution of titanium isopropoxide in toluene (1% by weight of titanium isopropoxide) are placed in a reactor. The mixture is stirred by mechanical stirring at 150 rpm and placed in an oven heated to 180° C. over the course of 15 min under a nitrogen stream. Still under a nitrogen stream, the oven is then maintained at 180° C. for 1 h, before being again heated to 210° C. over the course of 1 h. This temperature is maintained for 2 h in order to remove the maximum amount of methanol.

Following this, the oven temperature is increased to 290° C., the pressure is reduced over the course of 90 min to 0.7 mbar and the stirring speed is reduced to 50 rpm. These conditions are maintained for 3 h.

The polymer obtained is an amorphous polymer, the properties of which are reported in table 2 below.

### Example According to the Invention (Ex. 11)

51 parts of dimethyl terephthalate, 10 parts of ethylene glycol, 41 parts of tetrahydrofuran-dimethanol, 10 parts of isosorbide and 7.6 parts of a solution of titanium isopropoxide in toluene (1% by weight of titanium isopropoxide) are placed in a reactor. The mixture is stirred by mechanical stirring and is heated to 160° C. over the course of 30 min under a nitrogen stream. Still under a nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 270° C., and the pressure is reduced over the course of 90 min to 0.7 mbar with magnetic stirring. These conditions are maintained for 3 h.

The polymer obtained is an amorphous polymer, the properties of which are reported in table 2 below.

### Example According to the Invention (Ex. 12)

51 parts of dimethyl terephthalate, 17 parts of ethylene glycol, 7 parts of tetrahydrofuran-dimethanol, 32 parts of isosorbide and 7.3 parts of a solution of titanium isopropoxide in toluene (1% by weight of titanium isopropoxide) are placed in a reactor. The mixture is stirred by mechanical stirring and is heated to 160° C. over the course of 30 min under a nitrogen stream. Still under a nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 270° C., and the pressure is reduced over the course of 90 min to 0.7 mbar with magnetic stirring. These conditions are maintained for 3 h.

The polymer obtained is an amorphous polymer, the properties of which are reported in table 2 below.

### Example According to the Invention (Ex. 13)

49 parts of dimethyl terephthalate, 54 parts of tetrahydrofuran-dimethanol, 15 parts of isosorbide and 7.8 parts of a solution of titanium isopropoxide in toluene (1% by weight of titanium isopropoxide) are placed in a reactor. The mixture is stirred by mechanical stirring and is heated to 160° C. over the course of 30 min under a nitrogen stream. Still under a nitrogen stream, the mixture is then maintained at 160° C. for 1 h, before being again heated to 190° C. over the course of 30 min. This temperature is maintained for 2 h in order to remove the maximum amount of methanol.

Following this, the reactor temperature is increased to 270° C., and the pressure is reduced over the course of 90 min to 0.7 mbar with magnetic stirring. These conditions are maintained for 3 h.

The polymer obtained is an amorphous polymer, the properties of which are reported in table 2 below.

### Example According to the Invention (Ex. 14)

50 parts of dimethyl terephthalate, 35 parts of tetrahydrofuran-dimethanol, 9 parts of tetramethylcyclobutanediol, 12 parts of ethylene glycol and 5 parts of a solution of titanium isopropoxide in toluene (1% by weight of titanium isopropoxide) are placed in a reactor. The mixture is stirred by mechanical stirring and is heated to 210° C. over the course of 30 min under a nitrogen stream. Still under a nitrogen stream, the mixture is then maintained at 210° C. for 5 min, before being again heated to 260° C. over the course of 30 min. This temperature is maintained for 2 h in order to remove the maximum amount of methanol.

Following this, the reactor temperature is increased to 290° C., and the pressure is reduced over the course of 90 min to 0.7 mbar with magnetic stirring. These conditions are maintained for 100 min.

The polymer obtained is an amorphous polymer, the properties of which are reported in table 2 below.

### Example According to the Invention (Ex. 15)

50 parts of dimethyl terephthalate, 28 parts of tetrahydrofuran-dimethanol, 30 parts of tetramethylcyclobutanediol, 6 parts of ethylene glycol and 5 parts of a solution of titanium isopropoxide in toluene (1% by weight of titanium isopropoxide) are placed in a reactor. The mixture is stirred by mechanical stirring and is heated to 210° C. over the course of 30 min under a nitrogen stream. Still under a nitrogen stream, the mixture is then maintained at 210° C. for 5 min, before being again heated to 260° C. over the course of 30 min. This temperature is maintained for 2 h in order to remove the maximum amount of methanol.

Following this, the reactor temperature is increased to 290° C., and the pressure is reduced over the course of 90 min to 0.7 mbar with magnetic stirring. These conditions are maintained for 100 min.

The polymer obtained is an amorphous polymer, the properties of which are reported in table 2 below.

### Example According to the Invention (Ex. 16)

50 parts of dimethyl terephthalate, 55 parts of tetrahydrofuran-dimethanol, 15 parts of tetramethylcyclobutanediol and 6 parts of a solution of titanium isopropoxide in toluene (1% by weight of titanium isopropoxide) are placed in a reactor. The mixture is stirred by mechanical stirring and is heated to 210° C. over the course of 30 min under a nitrogen stream. Still under a nitrogen stream, the mixture is then maintained at 210° C. for 5 min, before being again heated to 260° C. over the course of 30 min. This temperature is maintained for 2 h in order to remove the maximum amount of methanol.

Following this, the reactor temperature is increased to 290° C., and the pressure is reduced over the course of 90 min to 0.7 mbar with magnetic stirring. These conditions are maintained for 100 min.

The polymer obtained is an amorphous polymer, the properties of which are reported in table 2 below.

### Example According to the Invention (Ex. 17)

50 parts of dimethyl terephthalate, 41 parts of tetrahydrofuran-dimethanol, 30 parts of tetramethylcyclobutanediol and 6 parts of a solution of titanium isopropoxide in toluene (1% by weight of titanium isopropoxide) are placed in a reactor. The mixture is stirred by mechanical stirring and is heated to 210° C. over the course of 30 min under a nitrogen stream. Still under a nitrogen stream, the mixture is then maintained at 210° C. for 5 min, before being again heated to 260° C. over the course of 30 min. This temperature is maintained for 2 h in order to remove the maximum amount of methanol.

Following this, the reactor temperature is increased to 290° C., and the pressure is reduced over the course of 90 min to 0.7 mbar with magnetic stirring. These conditions are maintained for 100 min.

The polymer obtained is an amorphous polymer, the properties of which are reported in table 2 below.

TABLE 2
Properties of polyesters according to the invention
comprising various cyclic aliphatic diol units (C2)

| Exam- | Nature of cyclic aliphatic | Tg | A/C1/C2 | Mw |
|---|---|---|---|---|
| ples | diol C2 | (° C.) | (mol/mol/mol) | (g/mol) |
| 9 | isosorbide | 58 | 74.7/14.7/10.6 | 83 100 |
| 10 | isosorbide | 58 | 68.2/21.6/10.2 | 11 650 |
| 11 | isosorbide | 61 | 78.4/10.4/11.2 | 11 900 |
| 12 | isosorbide | 79 | 24.4/37.8/37.8 | 9650 |
| 13 | isosorbide | 59 | 88.5/0/11.5 | 65 450 |
| 14 | tetramethylcyclobutanediol | 54 | 80.3/14.1/5.6 | 19 050 |
| 15 | tetramethylcyclobutanediol | 56 | 83/5.5/11.5 | 12 800 |
| 16 | tetramethylcyclobutanediol | 58 | 93.8/0/6.2 | 38 000 |
| 17 | tetramethylcyclobutanediol | 57 | 86.4/0/13.6 | 19 600 |

All the polymers according to the invention are amorphous. Furthermore, these tests show that it is also possible to modulate the glass transition temperature by adding other monomers to the polyester, and in particular other monomers of cycloaliphatic diol type other than tetrahydrofuran-dimethanol.

1. A thermoplastic polyester comprising diol units and aromatic acid units and wherein the polyester further comprises:
at least one tetrahydrofuran-dimethanol diol unit (A);
and at least one aromatic acid unit (B) chosen from terephthalic acid, isophthalic acid, phthalic acid, 2,6-naphthalenedicarboxylic acid and 1,4-naphthalenedicarboxylic acid;
the glass transition temperature of which is greater than or equal to 50° C.

2. The polyester as claimed in claim 1, wherein the aromatic acid units of the polyester consist of aromatic acid units (B) chosen from terephthalic acid, isophthalic acid, phthalic acid, 2,6-naphthalenedicarboxylic acid, 1,4-naphthalenedicarboxylic acid units, and mixtures thereof.

3. The polyester as claimed in claim 1, wherein the glass transition temperature is greater than or equal to 55° C., preferably greater than 60° C.

4. The polyester as claimed in claim 1, wherein the polyester has a degree of crystallinity of less than 50%, advantageously less than 35%.

5. The polyester as claimed in claim 1, wherein the polyester is amorphous.

6. The polyester as claimed in claim 1, wherein the polyester has a weight-average molar mass of greater than 7500 g/mol, preferably greater than 10 000 g/mol, most preferentially greater than 20 000 g/mol.

7. The polyester as claimed in claim 1, wherein the unit (B) is a terephthalic acid unit.

8. The polyester as claimed in claim 1, further comprising at least one aliphatic diol unit (C) other than the diol (A).

9. The polyester as claimed in claim 8, wherein the aliphatic diol unit (C) is a unit chosen from linear aliphatic diols (C1), cycloaliphatic diols (C2), branched aliphatic diols (C3), or a mixture of these units.

10. The polyester as claimed in claim 9, wherein the aliphatic diol unit (C) is a linear aliphatic diol unit (C1) or a mixture of these units (C1).

11. The polyester as claimed in claim 10, wherein the polyester comprises, relative to the total amount of diol units (A) and (C1):
from 1 to 99 units (A), advantageously from 5 to 90, preferentially from 20 to 80;
and from 1 to 99 units (C1), advantageously from 10 to 95, preferentially from 20 to 80.

12. The polyester as claimed in claim 9, wherein the aliphatic diol unit (C) is a cycloaliphatic diol unit (C2) or a mixture of these units (C2).

13. The polyester as claimed in claim 12, wherein the polyester comprises, relative to the total amount of diol units (A) and (C2):
from 1 to 99 units (A), advantageously from 5 to 98, preferentially from 80 to 95;
and from 1 to 99 units (C2), advantageously from 2 to 95, preferentially from 5 to 20.

14. The polyester as claimed in claim 9, wherein the aliphatic diol unit (C) comprises at least one mixture of at least one linear aliphatic diol unit (C1) and of at least one cycloaliphatic diol unit (C2).

15. The polyester as claimed in claim 14, wherein the polyester comprises, relative to the total amount of diol units (A) and (C):
from 1 to 98 units (A), advantageously from 5 to 90, preferentially from 20 to 85;
from 1 to 98 units (C1), advantageously from 5 to 60, preferentially from 5 to 40;
and from 1 to 98 units (C2), advantageously from 5 to 60, preferentially from 5 to 40.

16. The polyester as claimed in claim 9, wherein the polyester comprises at least one linear aliphatic diol unit (C1) chosen from ethylene glycol, 1,3-propanediol, 1,4-butanediol, 1,5-pentanediol, 1,6-hexanediol, 1,8-octanediol, 1,10-decanediol, or a mixture of aliphatic diol units comprising at least one of these units, preferentially ethylene glycol and 1,4-butanediol, very preferentially ethylene glycol.

17. The polyester as claimed in claim 9, wherein the cycloaliphatic diol unit (C2) comprises at least one unit chosen from the following units:

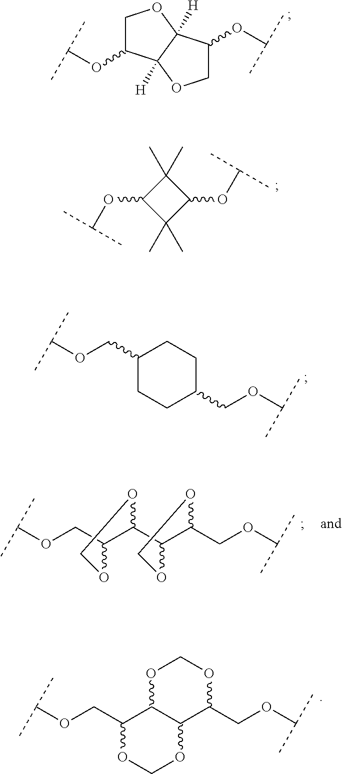

18. The polyester as claimed in claim 17, wherein the cycloaliphatic diol unit (C2) comprises at least one unit chosen from the following units: 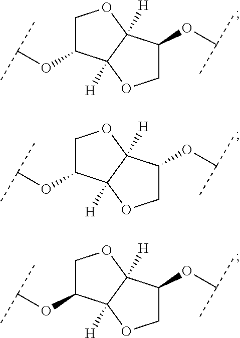
preferentially a unit:

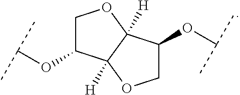

19. The polyester as claimed in claim 8, wherein the polyester comprises, relative to the total amount of diol units (A) and (C):
from 1 to 99 units (A), advantageously from 5 to 95;
and from 1 to 99 units (C), advantageously from 5 to 95.

20. A process for producing thermoplastic polyester, which comprises:
a step of introducing, into a reactor, monomers comprising at least one tetrahydrofuran-dimethanol diol (A), at least one aromatic acid (B) chosen from terephthalic acid, isophthalic acid, phthalic acid, 2,6-naphthalenedicarboxylic acid and 1,4-naphthalenedicarboxylic acid and/or a diester of this acid and optionally at least one aliphatic diol (C) other than the diol (A); and
a step of polymerizing the monomers so as to form the polyester, comprising:
a first stage during which the reaction medium is stirred, preferably under pressure or a stream of an inert gas, at a temperature ranging from 140 to 250° C. in order to form oligomers;
a second stage during which the oligomers formed are stirred under vacuum, at a temperature ranging from 230 to 310° C. in order to form the polyester;
a step of recovering the polyester at the end of the polymerizing step.

21. The process as claimed in claim 20, wherein, relative to the total moles of monomers (A), (B) and optional (C) introduced into the reactor, the molar percentage of acid and/or of acid diester (B) ranges from 25% to 45%.

22. A polyester that can be obtained according to the process of claim 20.
